(19) United States
(12) Patent Application Publication
(10) Pub. No.: US 2026/0309068 A1
(43) Pub. Date: Oct. 8, 2026

(54) COOLANT MODULE

(71) Applicant: Hanon Systems, Daejeon (KR)

(72) Inventors: Jeong Wan HAN, Daejeon (KR); Hyuk KIM, Daejeon (KR)

(73) Assignee: Hanon Systems, Daejeon (KR)

(21) Appl. No.: 19/136,840

(22) PCT Filed: Oct. 12, 2023
(86) PCT No.: PCT/KR2023/015703

§ 371 Date: Jun. 6, 2025

(30) Foreign Application Priority Data
Dec. 26, 2022 (KR) 10-2022-0184023

(51) Int. Cl. F01P 3/20; F01P 5/10; F01P 7/14

(52) U.S. Cl. CPC F01P 3/20; F01P 5/10; F01P 7/14; F01P 2007/146

(57) ABSTRACT

The present invention relates to a coolant module configured to be applied to a vehicle, and to a coolant module in which a coolant manifold and components may be integrated, thereby implementing miniaturization and weight reduction and reducing the number of components and the number of assembling processes. In addition, the present invention relates to a coolant module in which a through-hole is formed in a coolant manifold to prevent a vacant space excluding a coolant channel from being sealed, such that foreign substances or moisture may be discharged through the through-hole, damage caused by thermal expansion may be prevented, and whether a coolant leaks may be identified.

### TECHNICAL FIELD

The present invention relates to a coolant module configured to be applied to a vehicle, and to a coolant module in which a coolant manifold and components may be integrated, thereby implementing miniaturization and weight reduction and reducing the number of components and the number of assembling processes.

### BACKGROUND ART

An electric or hybrid vehicle is equipped with power electronic (PE) components including a motor, an inverter, an on-board charger (OBC), and the like. In addition, the electric or hybrid vehicle is equipped with a battery configured to provide electric power to the PE components.

Because the PE component and the battery generate heat while operating, the PE component and the battery need to be essentially cooled to protect the components and ensure durability. To this end, the electric or hybrid vehicle is equipped with a water-cooled PE cooling system for cooling the PE components and a water-cooled battery cooling system for cooling the battery.

Because the PE components and the battery are different in temperature ranges in main operating regions, i.e., the PE component operates at a relatively higher temperature than the battery, separate cooling systems are required for the PE components and the battery. Therefore, a PE cooling circuit for cooling the PE component by circulating a coolant through the PE component and a battery cooling circuit for cooling the battery by circulating a coolant through the battery are separately provided.

FIG. 1 is a view illustrating a cooling structure system for an electric vehicle in the related art. As illustrated, separate reservoir tanks R1 and R2 are independently provided for respective cooling circuits in order to operate separate cooling circuits. As described above, the electric vehicle in the related art is equipped with two reservoir tanks R1 and R2 used for the respective cooling circuits. However, it is difficult to mount the two reservoir tanks R1 and R2 in a narrow engine room, and the number of constituent elements increases, which causes a problem of an increase in manufacturing costs. In addition, the increase in number of constituent elements increases the weight, the increase in time required to mount the reservoir tanks degrades the productivity, and there is an inconvenience of having to perform maintenance separately on the respective cooling circuits.

### Document of Related Art (Patent Document 1) Korean Patent Application Laid-Open No. 10-2020-0031907 (published on March 25, 2020)

### DISCLOSURE

### Technical Problem

The present invention has been made in an effort to solve the above-mentioned problem, and an object of the present invention is to provide a coolant module in which a coolant manifold and components may be integrated, thereby implementing miniaturization and weight reduction and reducing the number of components and the number of assembling processes.

### Technical Solution

A coolant module according to one example of the present invention includes: a coolant manifold configured to provide a mounting space in which a coolant flows and a component is mounted, in which the coolant manifold includes a manifold plate, and a cover plate coupled to one surface of the manifold plate, in which a coolant channel through which the coolant flows is formed between the manifold plate and the cover plate, in which a partition wall, which defines a rim wall of the coolant channel, is installed on the manifold plate, and in which a through-hole, which is formed through the manifold plate, is formed in the manifold plate outside a region surrounded by the partition wall so that the coolant flows.

The through-hole may prevent a space, which excludes the coolant channel from a space between the manifold plate and the cover plate, from being sealed.

The cover plate may be coupled to the manifold plate by brazing, and foreign substances or moisture produced during the brazing may be discharged to the outside through the through-hole.

When the coolant leaks from the coolant channel, the leaking coolant may be discharged to the outside through the through-hole.

When air in a space, which excludes the coolant channel from a space between the manifold plate and the cover plate, is expanded by an increase in temperature of the coolant, the expanded air may be discharged to the outside through the through-hole.

The manifold plate may be disposed in a gravitational direction, the partition wall of the manifold plate may be disposed in a horizontal direction perpendicular to the gravitational direction, and when a partition wall portion of the partition wall, which is positioned at an upper side in the gravitational direction, is referred to as an upper partition wall, the through-hole may be disposed above the upper partition wall based on the gravitational direction.

The through-hole may be disposed to be in contact with an outer wall of the upper partition wall.

When the upper partition wall is formed to be curved or inclined in a longitudinal direction such that the upper partition wall includes an upper partition wall portion positioned at a relatively low position based on the gravitational direction, and an upper partition wall portion positioned at a relatively high position, the through-hole may be disposed above the upper partition wall portion positioned at the relatively low position based on the gravitational direction.

The coolant channel may be provided as a plurality of coolant channels, the partition wall may be provided as a plurality of partition walls to form the plurality of coolant channels, and at least one through-hole may be formed outside each of the plurality of partition walls.

A cover partition wall may protrude from the cover plate and be provided to be in contact with the partition wall of the manifold plate, and the cover partition wall of the cover plate and the partition wall of the manifold plate may be tightly attached and coupled to each other by brazing.

A portion where the partition wall of the manifold plate and the cover partition wall of the cover plate are in contact with each other may have a projection/recess engagement structure, such that the partition wall of the manifold plate and the cover partition wall may be fastened to each other.

The coolant manifold may further include: an orthogonal plate extending in a vertical direction from one edge of the manifold plate; and a mounting plate coupled to one surface of the orthogonal plate.

A coolant channel through which the coolant flows may be formed between the orthogonal plate and the mounting plate, and when a coolant channel formed between the manifold plate and the cover plate is referred to as a first coolant channel and a coolant channel formed between the orthogonal plate and the mounting plate is referred to as a second coolant channel, a partition wall, which defines a rim wall of the second coolant channel, may be installed on the orthogonal plate.

The first coolant channel may be provided as a plurality of first coolant channels, the second coolant channel may be provided as a plurality of second coolant channels, and at least any one of the plurality of first coolant channels and at least any one of the plurality of second coolant channels may communicate with each other.

The mounting plate may have a component mounting structure on which the component is mounted.

The coolant module may further include: a coolant valve and a water pump as the components, in which the coolant valve and the water pump are respectively mounted on the component mounting structures of the mounting plate.

The coolant module may further include: a reservoir tank configured to store the coolant as the component, in which the reservoir tank is disposed between the manifold plate and the orthogonal plate.

### Advantageous Effects

According to the present invention, the coolant manifold and the components may be integrated, thereby implementing miniaturization and weight reduction and reducing the number of components and the number of assembling processes.

In addition, the through-hole is formed in the coolant manifold to prevent the vacant space excluding the coolant channel from being sealed, such that foreign substances or moisture may be discharged through the through-hole, damage caused by thermal expansion may be prevented, and whether the coolant leaks may be identified.

### DESCRIPTION OF DRAWINGS

FIG. 1 is a view illustrating a cooling structure system for an electric vehicle in the related art.

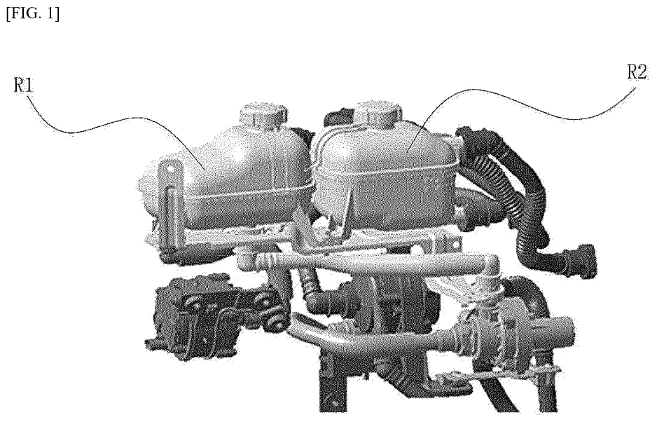

FIG. 2 is a perspective view illustrating a coolant module according to an example of the present invention when viewed from the front side.

FIG. 3 is an exploded perspective view of FIG. 2.

FIG. 4 is a perspective view illustrating a coolant manifold according to the example of the present invention.

FIG. 5 is a perspective view illustrating the coolant manifold in FIG. 4 when viewed in the opposite direction.

FIG. 6 is an exploded perspective view of the coolant manifold in FIG. 4.

FIG. 7 is a view illustrating one surface of a manifold plate.

FIG. 8 is an enlarged perspective view illustrating a periphery of a through-hole in FIG. 7.

### BEST MODE

Hereinafter, the present invention will be described with reference to the accompanying drawings.

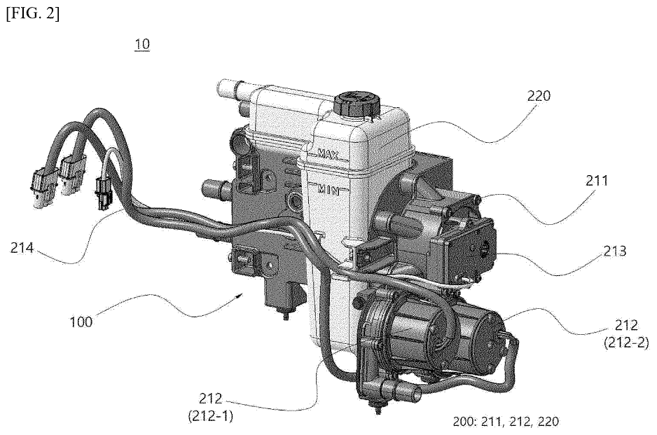

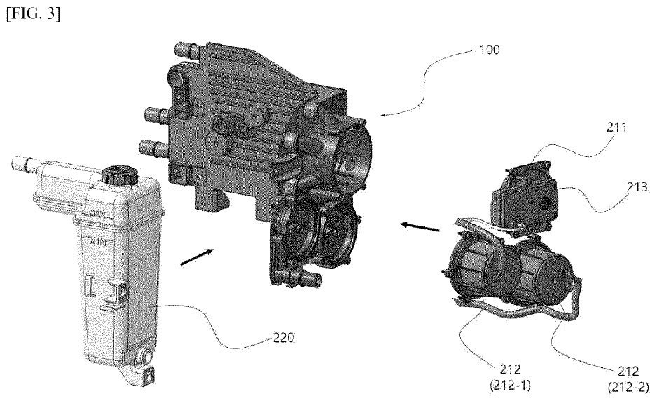

FIG. 2 is a perspective view illustrating a coolant module according to an example of the present invention when viewed from the front side, and FIG. 3 is an exploded perspective view of FIG. 2. As illustrated, a coolant module 10 of the present invention broadly includes a coolant manifold 100 and components 200.

First, the components 200 refer to various types of components applied to a vehicle cooling system. The components of the present invention may include a coolant valve 211, a water pump 212, and a reservoir tank 220.

The coolant valve 211 is configured as a multi-way switching valve and switches a transmission direction of a coolant. The water pump 212 pumps the coolant. The water pump may be configured as two or more water pumps 212-1 and 212-2.

Meanwhile, the coolant module 10 may have a controller 213 configured to control the coolant valve 211 and the water pump 212, and a connector 214 configured to supply power to the coolant valve, the water pump, and the controller. The controller may include a PCB on which electronic elements are mounted, and the controller may control the operations of the coolant valve and the water pump.

Next, the coolant manifold 100 is configured to provide a mounting space in which the coolant flows and the component 200 is mounted. The coolant manifold 100 provides a support structure in which a coolant channel may be formed therein and the above-mentioned component 200 may be mounted and coupled.

That is, the coolant module 10 of the present invention is made by collecting and integrating components in a cooling system in the related art, in which a reservoir tank, a coolant pump, a coolant valve, and the like are independently mounted in a vehicle and the components are connected by hoses to constitute a cooling circuit, into a single module by means of the coolant manifold.

Hereinafter, the coolant manifold of the present invention will be described in detail.

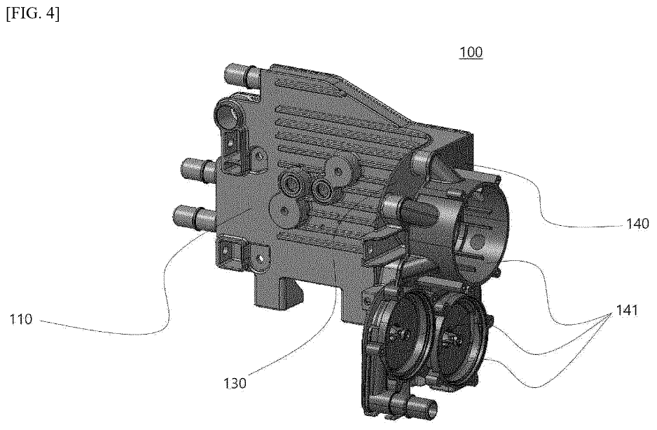

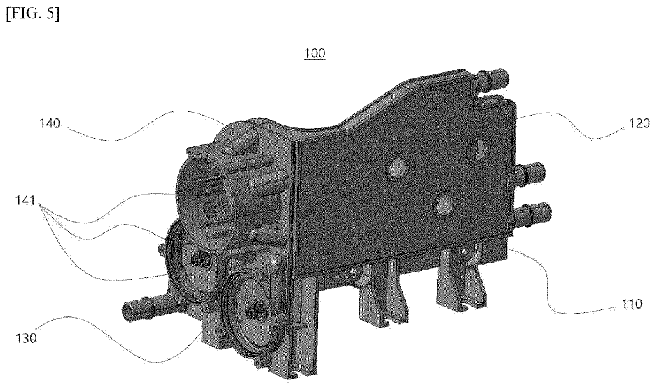

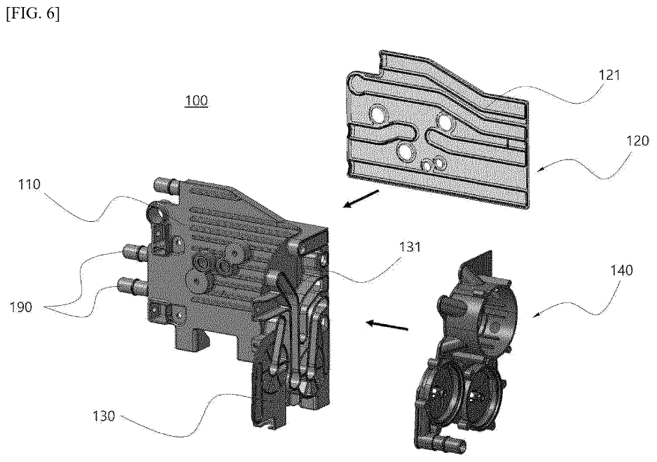

FIG. 4 is a perspective view illustrating the coolant manifold according to the example of the present invention, FIG. 5 is a perspective view illustrating the coolant manifold in FIG. 4 when viewed in the opposite direction, and FIG. 6 is an exploded perspective view of the coolant manifold in FIG. 4. As illustrated, the coolant manifold includes a manifold plate 110, and a cover plate 120 coupled to one surface of the manifold plate 110.

The manifold plate 110 and the cover plate 120 may be manufactured by injection molding and integrated and coupled by brazing. The cover plate 120 closes one open side of the manifold plate 110, and coolant channels (not illustrated separately), through which the coolant flows, are formed between the manifold plate 110 and the cover plate 120.

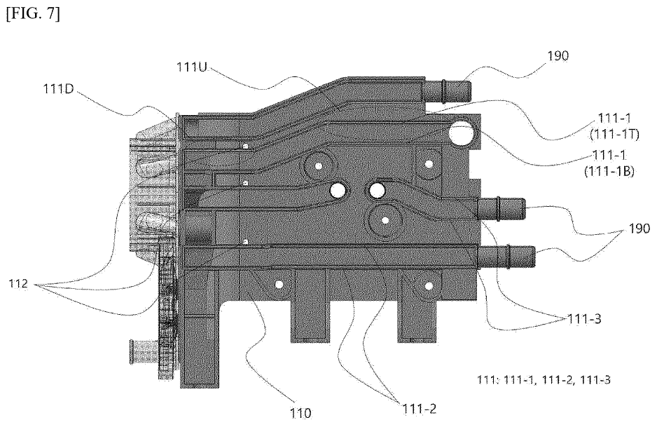

FIG. 7 is a view illustrating one surface of a manifold plate. Partition walls 111 are installed on the manifold plate 110 and define rim walls of the coolant channel. That is, the partition wall 111 perpendicularly protrudes from one surface of the manifold plate 110, and a portion surrounded by the partition wall 111 serves as the coolant channel.

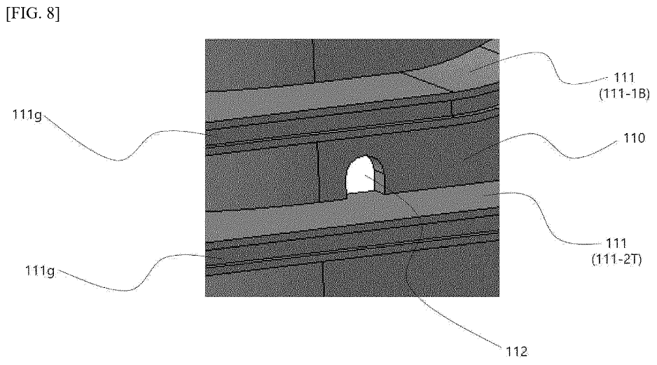

In this case, as illustrated, through-holes 112 are formed in the manifold plate 110, formed through the manifold plate 110, and disposed outside a region surrounded by the partition wall 111 so that the coolant flows (i.e., a region in which the coolant flows). FIG. 8 is an enlarged perspective view illustrating a periphery of the through-hole in FIG. 7 and illustrates that the through-hole 112 is formed outside the partition wall 111, i.e., outside the region in which the coolant flows. The through-hole 112 may be provided as one or more through-holes 112. As described below, one or more through-holes 112 may be formed for each of the coolant channels.

The through-hole 112 prevents a space (hereinafter, also referred to as a ‘vacant space’), which excludes the coolant channel from the space between the manifold plate 110 and the cover plate 120, from being sealed. That is, according to the present invention, the through-hole 112 may prevent the vacant space between the manifold plate 110 and the cover plate 120 from being sealed.

Therefore, foreign substances or moisture produced during the process of brazing the manifold plate 110 and the cover plate 120 may be discharged through the through-hole 112, which may prevent damage to the manifold caused by moisture or foreign substances.

In addition, a quality inspection may be performed through the through-hole 112. Specifically, in case that a gap is formed by a welding defect between the manifold plate 110 and the cover plate 120 or a crack occurs because of damage to or a manufacturing defect of the partition wall 111 of the manifold plate 110, the coolant leaks through the gap or crack, and the leaking coolant is discharged through the through-hole 112. Therefore, by monitoring the leak of the coolant, it is possible to identify a manufacturing defect of the coolant module or whether the coolant module is damaged by being used.

In addition, air, which is expanded by an increase in temperature of the coolant, is discharged to the outside through the through-hole 112, which may prevent damage to the manifold plate 110. Specifically, in case that a temperature of the coolant flowing in an internal space defined by the partition wall 111 of the manifold plate 110 is raised, the air in the vacant space positioned outside the partition wall 111 may be heated and expanded. In this case, in case that the vacant space is sealed, the expanded air may press the partition wall 111, which may cause a problem of bending of or damage to the partition wall 111. However, according to the present invention, because the expanded air is discharged to the outside through the through-hole 112, which may solve the above-mentioned problem.

With reference back to FIGS. 7 and 8, the manifold plate 110 is disposed in a gravitational direction, and the partition wall 111 of the manifold plate 110 is disposed in a horizontal direction perpendicular to the gravitational direction. In this case, when among the partition walls 111, a partition wall portion positioned at an upper side in the gravitational direction is referred to as an upper partition wall and a partition wall portion positioned at a lower side in the gravitational direction is referred to as a lower partition wall, the coolant channel is formed between the upper partition wall and the lower partition wall, and the through-hole 112 is disposed above the upper partition wall based on the gravitational direction.

With reference to FIG. 7, as illustrated, the coolant channels are provided as a plurality of coolant channels. In order to form the plurality of coolant channels, the plurality of partition walls 111 (111-1, 111-2, 111-3, etc.) of the manifold plate 110 are also installed. When the partition wall 111, which forms any one of the plurality of coolant channels, is referred to as a first partition wall 111-1, an upper portion of the first partition wall 111-1 in the gravitational direction corresponds to an upper partition wall 111-1T of the first partition wall 111-1, and a lower portion of the first partition wall 111-1 in the gravitational direction corresponds to a lower partition wall 111-1B of the first partition wall 111-1. In this case, as illustrated, the through-hole 112 is disposed above the upper partition wall 111-1T of the first partition wall 111-1. The upper portion of the upper partition wall 111-1T of the first partition wall 111-1 of course corresponds to the above-mentioned vacant space. Further, the through-hole 112 is disposed to be in contact with an outer wall of the upper partition wall 111-1T.

Because the through-hole 112 is disposed as described above, foreign substances or moisture, the coolant, and the like, which are moved downward in the gravitational direction by gravity, may be properly discharged through the through-hole 112 without stagnating in the vacant space.

Further, the through-hole 112 may be disposed at a relatively low position based on the gravitational direction. Specifically, with reference to FIG. 7, in case that the first partition wall 111-1, more specifically, the upper partition wall 111-1T of the first partition wall 111-1 is configured or inclined in a longitudinal direction so that the first partition wall 111-1 includes an upper partition wall portion 111U of the first partition wall positioned at a relatively low position based on the gravitational direction and an upper partition wall portion 111D positioned at a relatively high position, the through-hole 112 is disposed above the upper partition wall portion 111D of the first partition wall positioned at a relatively low position based on the gravitational direction. This is to smoothly discharge foreign substances or moisture, the coolant, and the like to the outside in case that the foreign substances or moisture, the coolant, and the like are moved downward along the upper partition wall portion 111 of the partition wall 111 by gravity.

In addition, with reference to FIG. 7, the through-hole 112 may be formed above the partition wall 111 for each of the plurality of partition walls 111. Because the through-hole 112 is provided for each of the partition walls 111 as described above, it is possible to improve the performance in discharging foreign substances and the like and the performance in detecting the leaking coolant. The drawings illustrate that the through-holes 112 are formed one by one in one partition wall 111. However, the design and modification may be performed so that one or two or more through-holes 112 are formed in one partition wall 111.

Meanwhile, with reference to FIG. 6, a cover partition wall 121 protrudes from the cover plate 120 and is provided to be in contact with the partition wall 111 of the manifold plate 110. Further, the cover partition wall 121 of the cover plate 120 and the partition wall 111 of the manifold plate 110 may be tightly attached and coupled to each other by brazing. In this case, the cover partition wall 121 of the cover plate 120 and the partition wall 111 of the manifold plate 110 may be fastened to each other by a projection/recess engagement of the tightly attached portions.

For example, with reference to FIG. 8, coupling grooves 111g, which each have a central portion recessed inward, may be formed in the upper portion (i.e., the portion being in contact with the cover partition wall 121) of the partition wall 111 of the manifold plate 110, and the upper portion (i.e., the portion being in contact with the partition wall 111 of the manifold plate 110) of the cover partition wall 121 of the cover plate 120 may be inserted and fastened into the coupling groove 111g. Alternatively, although not illustrated separately, coupling protrusions, which correspond to the coupling grooves 111g, may be formed on the upper portion of the cover partition wall 121 of the cover plate 120, and the coupling protrusion may be inserted and fastened into the coupling groove. Further, the fastening groove and the fastening structure of the projection/recess engagement structure may be designed in the opposite way. This configuration is advantageous in that the manifold plate 110 and the cover plate 120 may be coupled and temporarily fixed before the brazing process.

Next, an orthogonal plate 130 and a mounting plate 140 of the coolant manifold will be described. With reference back to FIG. 6, the coolant manifold 100 further includes the orthogonal plate 130 extending in the vertical direction from one edge of the manifold plate 110, and the mounting plate 140 coupled to one surface of the orthogonal plate 130. The orthogonal plate 130 may be integrated with the manifold plate 110 by being injection-molded simultaneously with the manifold plate 110, and the mounting plate 140 may be separately injection-molded and coupled to the orthogonal plate 130 by brazing.

A coolant channel (not illustrated separately), through which the coolant flows, is formed between the orthogonal plate 130 and the mounting plate 140. Like the above-mentioned manifold plate 110, partition walls 131, which define rim walls of the coolant channel, are formed on the orthogonal plate 130.

In this case, when the coolant channel formed between the manifold plate 110 and the cover plate 120 is referred to as a first coolant channel and the coolant channel formed between the orthogonal plate 130 and the mounting plate 140 is referred to as a second coolant channel, the first coolant channel is provided as a plurality of first coolant channels, the second coolant channel is provided as a plurality of second coolant channels, and at least any one of the plurality of first coolant channels and at least any one of the plurality of second coolant channels communicate with each other. Because the first coolant channel and the second coolant channel communicate with each other as described above, the coolant may circulate in the coolant manifold 100.

In addition, as illustrated in FIG. 6 and the like, at least one coolant pipe 190 through which the coolant is introduced or discharged may be formed on the coolant manifold 100. The coolant pipe 190 is configured to communicate with any one of the first coolant channel and the second coolant channel, such that the coolant may be introduced into the coolant manifold 100 from the outside, or the coolant in the coolant manifold 100 may be discharged to the outside.

Meanwhile, component mounting structures 141, on which the components 200 may be mounted, may be formed on the mounting plate 140, and the components 200 may be mounted on the component mounting structures 141 and constitute the coolant module 10.

More specifically, with reference back to FIGS. 2 and 3, the coolant module 10 may further include the coolant valve 211 and the water pump 212 as the components 200, and the coolant valve 211 and the water pump 212 may be respectively mounted on the component mounting structures 141 of the mounting plate 140. The water pump 212 may be provided as a plurality of water pumps 212-1 and 212-2 that correspond to the plurality of cooling circuits. The water pump 212 and the coolant valve 211 may be structured to communicate with the second coolant channel and configured to pump the coolant flowing along the second coolant channel or switch the transmission direction. Meanwhile, as illustrated, the controller 213 may be mounted at one side of the coolant valve 211, and the connector 214 may be further provided to supply power to the controller and the water pump.

Further, the coolant module 10 may further include the reservoir tank 220, which is configured to store the coolant, as the component 200. The reservoir tank 220 may be disposed between the manifold plate 110 and the orthogonal plate 130. This arrangement structure assists in improving the overall packaging performance of the coolant module 10.

While the embodiments of the present invention have been described with reference to the accompanying drawings, those skilled in the art will understand that the present invention may be carried out in any other specific form without changing the technical spirit or an essential feature thereof. Therefore, it should be understood that the above-described embodiments are illustrative in all aspects and do not limit the present invention.

### Description of Reference Numerals

10: Coolant module
100: Coolant manifold
110: Manifold plate
111: Partition wall
112: Through-hole
120: Cover plate
121: Cover partition wall
130: Orthogonal plate
140: Mounting plate
200: Component
211: Coolant valve
212: Water pump

1. A coolant module comprising:
a coolant manifold configured to provide a mounting space in which a coolant flows and a component is mounted,
wherein the coolant manifold comprises a manifold plate, and a cover plate coupled to one surface of the manifold plate,
wherein a coolant channel through which the coolant flows is formed between the manifold plate and the cover plate,
wherein a partition wall, which defines a rim wall of the coolant channel, is installed on the manifold plate, and
wherein a through-hole, which is formed through the manifold plate, is formed in the manifold plate outside a region surrounded by the partition wall so that the coolant flows.

2. The coolant module of claim 1, wherein the through-hole prevents a space, which excludes the coolant channel from a space between the manifold plate and the cover plate, from being sealed.

3. The coolant module of claim 2, wherein the cover plate is coupled to the manifold plate by brazing, and
wherein foreign substances or moisture produced during the brazing is discharged to the outside through the through-hole.

4. The coolant module of claim 2, wherein when the coolant leaks from the coolant channel, the leaking coolant is discharged to the outside through the through-hole.

5. The coolant module of claim 2, wherein when air in a space, which excludes the coolant channel from a space between the manifold plate and the cover plate, is expanded by an increase in temperature of the coolant, the expanded air is discharged to the outside through the through-hole.

6. The coolant module of claim 1, wherein the manifold plate is disposed in a gravitational direction,
wherein the partition wall of the manifold plate is disposed in a horizontal direction perpendicular to the gravitational direction, and
wherein when the partition wall positioned at an upper side in the gravitational direction is referred to as an upper partition wall, the through-hole is disposed above the upper partition wall based on the gravitational direction.

7. The coolant module of claim 6, wherein the through-hole is disposed to be in contact with an outer wall of the upper partition wall.

8. The coolant module of claim 6, wherein when the upper partition wall is formed to be curved or inclined in a longitudinal direction such that the upper partition wall includes an upper partition wall portion positioned at a relatively low position based on the gravitational direction, and an upper partition wall portion positioned at a relatively high position, the through-hole is disposed above the upper partition wall portion positioned at the relatively low position based on the gravitational direction.

9. The coolant module of claim 1, wherein the coolant channel is provided as a plurality of coolant channels,
wherein the partition wall is provided as a plurality of partition walls to form the plurality of coolant channels, and
wherein at least one through-hole is formed outside each of the plurality of partition walls.

10. The coolant module of claim 1, wherein a cover partition wall protrudes from the cover plate and is provided to be in contact with the partition wall of the manifold plate, and
wherein the cover partition wall of the cover plate and the partition wall of the manifold plate are tightly attached and coupled to each other by brazing.

11. The coolant module of claim 10, wherein a portion where the partition wall of the manifold plate and the cover partition wall of the cover plate are in contact with each other has a projection/recess engagement structure, such that the partition wall of the manifold plate and the cover partition wall are fastened to each other.

12. The coolant module of claim 1, wherein the coolant manifold further comprises:
an orthogonal plate extending in a vertical direction from one edge of the manifold plate; and
a mounting plate coupled to one surface of the orthogonal plate.

13. The coolant module of claim 12, wherein a coolant channel through which the coolant flows is formed between the orthogonal plate and the mounting plate, and
wherein when a coolant channel formed between the manifold plate and the cover plate is referred to as a first coolant channel and a coolant channel formed between the orthogonal plate and the mounting plate is referred to as a second coolant channel, a partition wall, which defines a rim wall of the second coolant channel, is installed on the orthogonal plate.

14. The coolant module of claim 13, wherein the first coolant channel is provided as a plurality of first coolant channels,
wherein the second coolant channel is provided as a plurality of second coolant channels, and
wherein at least any one of the plurality of first coolant channels and at least any one of the plurality of second coolant channels communicate with each other.

15. The coolant module of claim 12, wherein the mounting plate has a component mounting structure on which the component is mounted.

16. The coolant module of claim 15, further comprising:
a coolant valve and a water pump as the components,
wherein the coolant valve and the water pump are respectively mounted on the component mounting structures of the mounting plate.

17. The coolant module of claim 15, further comprising:
a reservoir tank configured to store the coolant as the component,
wherein the reservoir tank is disposed between the manifold plate and the orthogonal plate.
